(19) United States
(12) Patent Application Publication
(10) Pub. No.: US 2009/0073880 A1
(43) Pub. Date: Mar. 19, 2009

(54) SYSTEM AND METHOD FOR CONTROLLING CONGESTION IN A DEDICATED SHORT RANGE COMMUNICATION SYSTEM

(75) Inventors: Pu Sik Park, Gyeonggi-do (KR); Dae Kyo Shin, Seoul (KR); Ki Tag Lim, Gyeonggi-do (KR); Jae Min Kwak, Gyeonggi-do (KR); Jong Chan Choi, Gyeonggi-do (KR)

Correspondence Address: FOLEY & LARDNER LLP, 150 EAST GILMAN STREET, P.O. BOX 1497, MADISON, WI, 53701-1497, US

(73) Assignee: Korea Electronics Technology Institute

(21) Appl. No.: 12/158,889

(22) PCT Filed: Dec. 27, 2006
(86) PCT No.: PCT/KR2006/005762

§ 371 Date: Oct. 19, 2008

(30) Foreign Application Priority Data
Dec. 28, 2005 (KR) 1020050131276

(51) Int. Cl. H04L 12/24; H04B 7/00

(52) U.S. Cl. 370/235; 455/41.2

(57) ABSTRACT

A system and method is disclosed for controlling congestion in communications between an RSE and multiple OBEs in a DSRC system. In certain embodiments, a system and method for controlling congestion in communications between an RSE and multiple OBEs includes determining a priority level for each of multiple OBEs with respect to reserving a channel between each OBE and an RSE. Based on this determination, each OBE is assigned a waiting period based on their respective priority levels. The OBEs then send requests to reserve a channel to the RSE after waiting the assigned waiting periods.

### TECHNICAL FIELD

The present disclosure relates generally to systems and methods for controlling congestion in a communication system and, more particularly, to priority scheduling for on-board equipment contending to transmit data packets to a road-side equipment in a dedicated short range communication system.

### BACKGROUND ART

Intelligent transport systems (ITS) have been gaining importance due to their potential to reduce traffic congestion and air pollution. In general, an ITS utilizes a simple base station, typically called road-side equipment (RSE), and a low-cost mobile terminal installed in a moving vehicle, usually referred to as on-board equipment (OBE). It is often critical that an ITS maintain real-time communication between mobile terminals and base stations in applications providing vehicle safety (e.g., vehicle collision avoidance), subscription-based mobile user services (e.g., user notification), and environmental monitoring. Dedicated Short Range Communication (DSRC) is a wireless communication protocol commonly used to provide real-time communication between RSEs and OBEs within about a one-hundred meter radius from a source.

For example, when an ITS is used to collect information about vehicles moving on a road, a simple, high-speed communication protocol is generally required to enable an RSE to send and receive data packets from a fast moving vehicle (i.e., an OBE) over a short duration (e.g., tens of milliseconds). Furthermore, a short range mobile communication channel typically requires a line-of-sight for communication and has a relatively small error rate of about 10⁻⁶. The DSRC protocol architecture of the prior art typically utilizes only three of the seven layers in the open systems interconnection (OSI) reference model—the physical layer, the data link layer, and the application layer.

Several communication protocol standards for DSRC have been proposed, each of which defines different specifications for each of the three layers utilized by DSRC. Among the three layers of the DSRC protocol stack, the data link layer includes a media access control (MAC) layer and a logical link control (LLC) layer, whereby the MAC layer controls access to a physical medium connecting the RSF to an OBE. In general, access to the physical medium is controlled by an RSE, which employs time division multiple access (TDMA) to communicate with multiple OBEs.

For example, TTA (Korean Telecommunications Technology Association) DSRC standard (TTAS.KO-06.0025) defines a configuration for a physical medium for communicating over the 5.8 GHz microwave band. As shown in FIG. 1, in the MAC layer, an RSE communicates with an OBE in a synchronous mode using a time frame 100 which may include a frame control message slot (FCMS) 102, one or more message data slots (MDS) 104, and one or more activation slots (ACTS) 106. As illustrated, an FCMS 102, which may be positioned at a first slot in the time frame, may be used by an RSE to provide an OBE with status information regarding communication channel usage. One or more MDSs 104 may be positioned after the FCMS 102 to transmit message data between an RSE and an OBE. One or more ACTS 106 may be used by an OBE to request that an RSE allocate MDSs to the OBE for transmitting message data.

In order to communicate with an RSE, an OBE typically makes an association with the RSE using an LID (Link ID) unique to the OBE so that one or more of the MDSs in the time frame may be reserved for data communication therebetween. In order to avoid the collisions resulting from multiple OBEs trying to gain access to an RSE over the same physical medium, a DSRC system may employ a slotted ALOHA (s-ALOHA) protocol. In an s-ALOHA scheme, an OBE may send a time frame with an ACTS (including its LID) to an RSE before the transmission of each frame to reserve a communication channel. If the RSE is ready to receive data packets and the channel is reserved for the packet transmission, the RSE replies to the OBE with a time frame that includes an FCMS which specifies one or more MDSs assigned to the LID. The OBE receives and decodes the FCMS to identify its LID and MDSs associated with the LID. The OBE can then start transmitting data packets through the MDSs associated with the LID.

Because the data packets are transmitted by the OBE through the MDSs assigned by the RSE in the s-ALOHA scheme, data packet collisions do not occur. However, when an OBE attempts to reserve a channel to the RSE, a collision may still occur since multiple OBEs may be contending to access the channel. In order to avoid such collisions, AP (activation probability) may be used to determine the probability of an OBE obtaining access to a channel. For example, according to the TTA DSRC standard, an RSE may periodically send an FCMS with an AP value to multiple OBEs. This AP value may become larger as the percentage of idle time frames increases.

FIG. 2 shows a block diagram describing a method for reserving a channel between an RSE and an OBE in a DSRC system 200 that employs an s-ALOHA scheme with AP values. As shown, an RSE 210 may have an AP of 20% based on a current network congestion status, and send the AP to multiple OBEs 220, 230, 240, 250 through an FCMS. Assuming that the OBEs 220, 230, 240, 250 have APs of 15%, 35%, 10%, and 75%, respectively, the OBEs 220, 240 have APs less than that of the RSE 210. The OBEs 220, 240 having APs lower than the RSE 210 send requests to the RSE 210 to reserve a channel through ACTSs, whereas the OBEs 230, 250 having APs greater than the RSE 210 wait another time slot to send a request to reserve a channel. In this case, the request from the OBE 220 may collide with that from the OBE 240, even if the request of the OBE 220 has priority over that of the OBE 240 for various reasons. Consequently, this creates in efficient utilization of the communication channel due to frequent collisions between multiple OBEs vying to reserve a channel with an RSE.

In view of the foregoing, what are needed are systems and methods for avoiding collisions resulting from multiple OBES.

### DISCLOSURE OF INVENTION

### Technical Solution

In one embodiment, a method of communicating between an RSE and multiple OBEs includes determining a priority level for each of multiple OBEs with respect to reserving a channel between each OBE and an RSE. Based on this determination, each OBE is assigned a waiting period consistent with their respective priority levels. The OBEs then send requests to reserve a channel to the RSE after waiting the assigned waiting periods.

In other embodiments, the method may further include performing carrier sensing to check if an idle activation channel is available to carry the request prior to sending a request to reserve a channel. If an idle activation channel is available, the method may include sending a request to the RSE to reserve a channel. In other embodiments, the method may include determining whether to send the request based on activation probability (AP) values of the OBEs in the event the idle activation channel is available. These AP values may be determined based on current network congestion status. If the AP values of the OBEs are less than an AP value of the RSE, the OBEs send a request to reserve a channel to the RSE. The RSE may then reserve a channel for transmitting data packets in response to the request from the OBEs.

In other embodiments, the waiting periods of OBEs having a higher priority level are shorter than the waiting periods of OBEs having a lower priority level. Similarly, in certain embodiments, the priority levels of OBEs paying higher DSRC service subscription fees are assigned higher priority levels than those paying lower DSRC service subscription fees.

In another embodiment, a DSRC system includes an RSE and multiple OBEs. Each of the OBEs is assigned a priority level with respect to reserving a channel between each OBE and an RSE. The OBE's are then assigned a waiting period based on their priority levels. These OBEs are configured to send a request to the RSE to reserve a channel after waiting the assigned waiting period.

### BRIEF DESCRIPTION OR THE DRAWINGS

The drawings depict only embodiments and are, therefore, not to be considered limiting of its scope.

FIG. 1 illustrates one embodiment of a time frame including an FCMS, one or more MDSs, and one or more ACTSs, through which an RSE communicates with an OBE in the MAC layer of the DSRC protocol architecture.

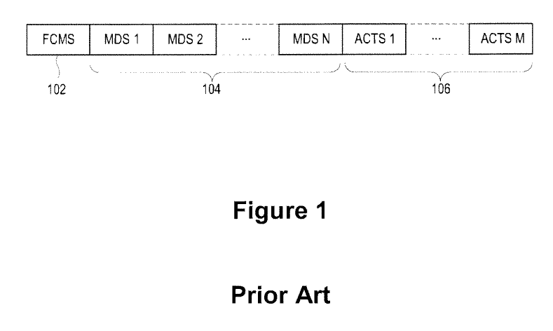

FIG. 2 is a block diagram of one embodiment of a method for reserving a channel between an RSE and an OBE in a DSRC system employing an s-ALOHA scheme using AP values.

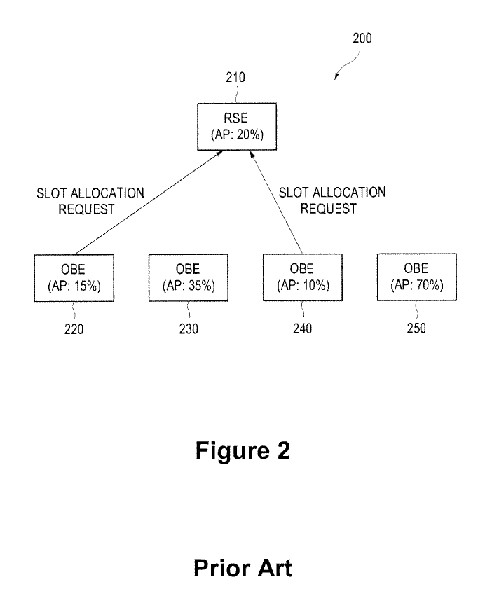

FIG. 3 is a block diagram of one embodiment of a DSRC system showing multiple OBEs contending to reserve a channel to an RSE.

FIG. 4 is a block diagram of one embodiment of a DSRC system showing multiple applications running on OBEs contending to reserve a channel to an RSE.

FIG. 5 is a block diagram showing one embodiment of a DSRC protocol stack implemented in an OBE.

FIG. 6 is a flowchart describing one embodiment of a method for reserving a communication channel between an RSE and multiple OBEs in a DSRC system.

FIG. 7 is a more detailed flowchart showing one embodiment of a method for reserving a communication channel between an RSE and multiple OBEs in a DSRC system.

### MODE FOR THE INVENTION

It will be readily understood that the components, as generally described and illustrated in the Figures herein, could be arranged and designed in a wide variety of different configurations. Thus, the following more detailed description of the embodiments of systems and methods, as represented in the Figures, is not intended to limit the scope of the disclosure, but is merely representative of certain examples of presently contemplated embodiments. The presently described embodiments will be best understood by reference to the drawings, wherein like parts are designated by like numerals throughout.

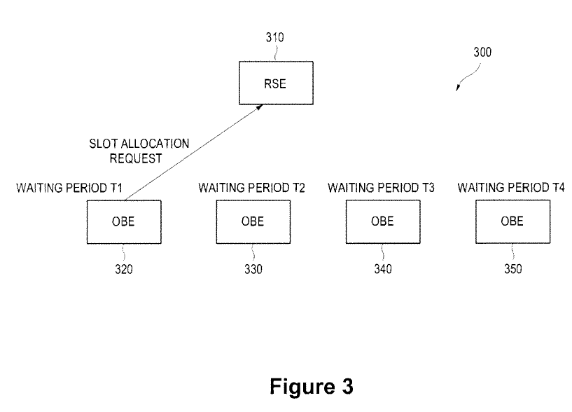

Referring to FIG. 3, one embodiment of a DSRC system 300 showing multiple OBEs contending to reserve a channel to an RSE is illustrated. As shown, the DRSC system 300 includes an RSE 310 and multiple OBEs 320, 330, 340, 350 vying to reserve a channel to the RSE 310. The RSE 310 communicates with the OBEs 320, 330, 340, 350 through a DSRC frame including one or more time slots. For example, according to the TTA DSRC standard described above, a DSRC frame includes one FCMS, one or more MDSs, and one or more ACTSs.

The RSE 310 periodically transmits an FCMS to the OBEs 320, 330, 340, 350 within its range of wireless communication. This FCMS includes an AP value reflecting the current network congestion status and information about the configuration of the MDSs and ACTSs. To establish a communication channel with the RSE 310 to transmit a data packet thereto, the OBEs 320, 330, 340, 350 must normally send a request to reserve a channel to the RSE 310 through an ACTS. In response, the RSE 310 may then allocate or reserve one or more MDSs which are associated with the LID of the OBE sending the request.

In some cases, a collision may occur when two or more OBEs simultaneously transmit requests to an RSE 310 through an identical ACTS. In order to prevent such a collision, the OBEs 320, 330, 340, 350 may be configured to wait predetermined periods before sending requests to reserve a channel to the RSE 310. The waiting periods may be different for each OBE 320, 330, 340, 350 depending on a priority level determined for each OBE 320, 330, 340, 350.

For example, as shown in FIG. 3, OBEs 320, 330, 340, 350 may be assigned waiting periods T1, T2, T3, and T4, respectively. Each of the OBEs 320, 330, 340, 350 may be configured to wait the assigned period prior to assessing whether any idle activation channels (i.e., ACTSs) are available. After the waiting periods have elapsed, the OBEs 320, 330, 340, 350 may determine whether idle activation channels are available by performing carrier sensing in order to send request to reserve a channel to the RSE 310.

Assuming that T1<T2<T3<T4, the OBE 320 having the shortest waiting period T1 has the greatest chance of being able to send the request to the RSE 310. In the event an idle activation channel is available, the OBE 320 may determine whether or not to send its request based on its AP value. For example, if the AP value of the OBE 320 is less than that of the RSE 310, the OBE 320 may then send a request to the RSE 310 to reserve a channel. In response to this request, the RSE 310 may then reserve a channel for transmitting data packets between the OBE 320 and the RSE 310. This includes sending an FCMS to the OBE 320 containing information with respect to the MDS associated with the LID of the OBE 320.

Similarly, the other OBEs 330, 340, 350 may also wait their assigned waiting periods prior to assessing whether any idle activation channels (i.e., ACTSs) are available. After their waiting periods have elapsed, the OBEs 330, 340, 350 may then determine whether any idle activation channels are available. If the OBEs 330, 340, 350 senses that the activation channel is in use and that there are no other idle activation slots, the OBEs 330, 340, 350 may delay data packet transmission for another waiting period.

In certain embodiments, the waiting period assigned to each of the OBE may be determined based on a priority level for each OBE. For example, an OBE having a higher priority level may be assigned a shorter waiting period. In other cases, the waiting periods may be set by a manufacturer of the OBE or may be assigned by the RSE 310 through an FCMS. In certain embodiments, an OBE paying higher DSRC service subscription fees may be given a higher priority level than those paying lower DSRC service subscription fees. Furthermore, by assigning different waiting periods to OBEs based on their priority levels, various QoS levels may be provided to different OBEs. In addition, the number of collisions caused by OBEs trying to access a channel may be significantly reduced by distributing the requests from each OBE over a period of time.

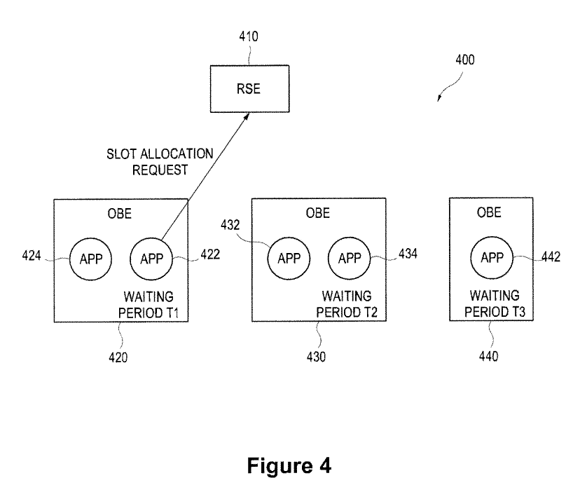

Referring now to FIG. 4, in other embodiments, priority levels may be determined based on applications running on the OBEs. For example, an application having a higher priority level may be assigned a shorter waiting period before sending a request to reserve a channel to the RSE. As shown in FIG. 4, multiple applications 422, 424, 432, 434, 442 running on OBEs 420, 430, 440 may contend to reserve a channel to an RSE 410. The DSRC system 400 shown in FIG. 4 may have the same or a similar configuration to the system 300 shown in FIG. 3 except that instead of the OBEs, the applications wait the assigned waiting periods prior to sending a request to the RSE 410 to reserve a channel.

For example, an application 422 running on an OBE 420 may be assigned a shorter waiting period T1 than the waiting periods T2, T3 assigned to the applications 432, 442 running on OBEs 430, 440. As a result, the application 422 may have a greater chance of being able to send a request to an RSE 410 compared to applications 432 and 442. The process to reserve a channel connecting an OBE to an RSE that was described in association with FIG. 3 may also be applied to the embodiment described in association with FIG. 4. Similarly, waiting periods assigned to multiple applications running on OBEs may be determined based on priority levels determined for each of the applications, as described in association with FIG. 3.

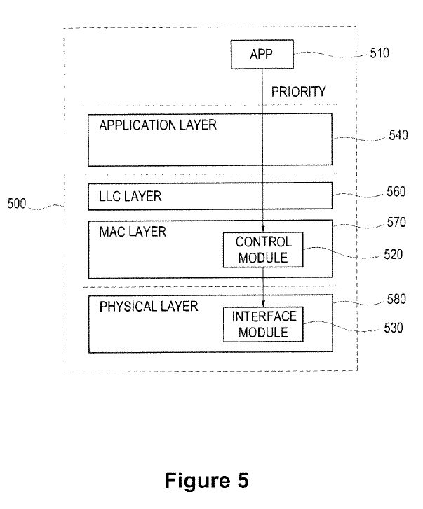

Referring to FIG. 5, in certain embodiments, a process for reserving a channel between an OBE (or an application running on an OBE) and an RSE may be implemented as a control module 520 in a MAC layer 570 of the DSRC protocol architecture implemented in an OBE 500. For example, in order for an application module 510 to transmit data packets to an RSE, an application module 510 may transfer data packets together with information on its priority level to a control module 520 in the MAC layer 570. This may occur through an application layer 540 and an LLC layer 560. The control module 520 may then send the priority level information to an interface module 530 in a physical layer 530.

Still referring to FIG. 5, in certain embodiments, the control module 520 may store a table for mapping the priority levels of applications to corresponding waiting periods. In such embodiments, the control module 520 may retrieve a waiting period corresponding to the priority level of the application 510 and send this waiting period to the interface module 530. The interface module 530 may then wait the required waiting period prior to determining whether an idle activation channel (i.e., ACTS) is available. If an idle activation channel is available, the control module 520 may then determine whether or not to send a request by analyzing an AP value of the OBE 500. If the AP value of the OBE is less than the AP value of the RSE, the interface module 530 may send a request to the RSE to reserve a channel through an ATCS.

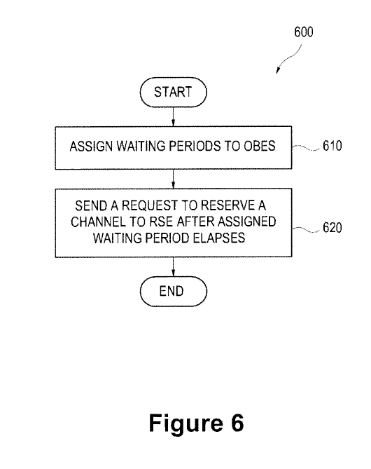

Referring now to FIG. 6, in one embodiment, a method 600 for reserving a communication channel between an RSE and multiple OBEs may include the step of assigning waiting periods 610 to one or more OBEs. For example, the OBEs may be assigned waiting periods T1 through T4 as described in association with FIG. 3. If an OBE has a data packet to send to the RSE, the OBE may send a request to the RSE to reserve a channel 620 after the assigned waiting period elapses. In certain embodiments, waiting periods may be determined based on priority levels designated for each of the OBEs. For example, an OBE having a higher priority level may be assigned a shorter waiting period. In other embodiments, priority levels may also be determined for applications running on the OBEs. In such cases, an application having a larger priority level may also be assigned a shorter waiting period.

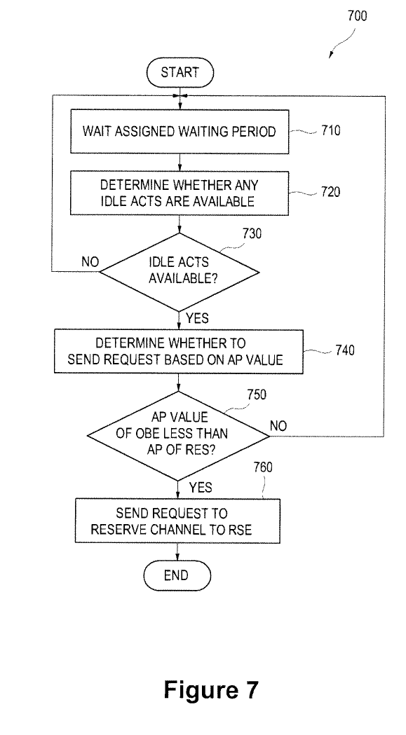

Referring now to FIG. 7, one embodiment of a method 700 for reserving a communication channel between an RSE and multiple OBEs is illustrated. As shown, if an OBE has a data packet to send to the RSE, the OBE waits the assigned waiting period 710. The OBE then determines whether an idle ATCSs is available 720 to send a request to the RSE to reserve a channel. If, at a decision step 730, it is determined that an idle activation channel is available, the OBE then determines whether to send a request by comparing its AP value to the AP value of the RSE 740. In the event an idle activation channel is not available, the OBE will then wait 710 another waiting period (i.e., returning to the beginning of the method 700).

If, at the decision step 750, the AP value of the OBE is less than that of the RSE, the OBE then sends a request to the RSE to reserve a channel 760 through an ATCS. If, on the other hand, the AP value of the OBE is greater than or equal to the AP value of the RSE, the OBE waits 710 another waiting period, returning to the beginning of the method 700. If the RSE receives a request from the OBE, the RSE may then reserve a channel for transmitting data packets between the OBE and the RSE. The RSE may also send an FCMS to the OBE which contains information with respect to the MDS associated with the LID of the OBE. Sensing that the available activation channel is in use by the OBE and/or there are no other idle activation slots, the other OBEs may delay the transmission of their data packets another waiting period.

While the embodiments referred to herein have been described in association with particular DSRC standard, it should be noted that the embodiments may be used with other DSRC standards such as CEN (Center for European Normalization), ASTM (American Society for Testing and Materials), IEEE WG P1455, or other analogous standards.

It should also be appreciated that the systems and methods described herein may be implemented in hardware, software, firmware, middleware, or combinations thereof and utilized in systems, subsystems, components, or sub-components thereof. For example, a method implemented in software may include computer code to perform the steps of the method. This computer code may be stored in a machine-readable medium, such as a processor-readable medium or a computer program product, or transmitted as a computer data signal embodied in a carrier wave, or a signal modulated by a carrier, over a transmission medium or communication link. The machine-readable medium or processor-readable medium may include any medium capable of storing or transferring information in a form readable and executable by a machine (e.g., a processor, a computer, etc.).

The described embodiments are to be considered in all respects only as illustrative, and not restrictive. All changes within the meaning and range of equivalency of the claims are to be embraced within their scope.

1. A method for controlling congestion in communications between road-side equipment (RSE) and on-board equipment (OBE) in a dedicated short range communication (DSRC) system, the method comprising the steps of:
determining a priority level for each of a plurality of OBEs with respect to reserving a channel between each OBE and an RSE;
assigning a waiting period to each of the plurality of OBEs based on their respective priority levels; and
sending, by the OBEs, requests to reserve a channel to the RSE after waiting the assigned waiting periods.

2. The method as defined in claim 1, further comprising the steps of:
performing carrier sensing to check if an idle activation channel is available to carry the request prior to sending a request to reserve a channel; and
sending a request to reserve a channel to the RSE if the idle activation channel is available.

3. The method as defined in claim 2, further comprising the steps of:
determining whether to send the request based on activation probability (AP) values of the OBEs if the idle activation channel is available, wherein the AP values are determined based on current network congestion status; and
sending a request to reserve a channel to the RSE if the AP values of the OBEs are less than an AP value of the RSE.

4. The method as defined in claim 1, further comprising the step of reserving, by the RSE, a channel for transmitting data packets in response to the request from the OBEs.

5. The method as defined in claim 1, wherein the waiting periods of OBEs having a higher priority level are shorter than the waiting periods of OBEs having a lower priority level.

6. The method as defined in claim 1, wherein the priority levels of OBEs paying higher DSRC service subscription fees are assigned higher priority levels than those paying lower DSRC service subscription fees.

7. A method for controlling congestion in communications between an RSE and a plurality of applications running on OBEs in a DSRC system, the method comprising the steps of:
determining a priority level for each of a plurality of OBEs with respect to reserving a channel between each OBE and an RSE;
assigning a waiting period to each of the plurality of OBEs based on their respective priority levels; and
sending, by the OBEs, requests to reserve a channel to the RSE after waiting the assigned waiting periods.

8. The method as defined in claim 7, further comprising the steps of:
performing carrier sensing to check if an idle activation channel is available to carry the request prior to sending a request to reserve a channel; and
sending a request to reserve a channel to the RSE if the idle activation channel is available.

9. The method as defined in claim 8, further comprising the steps of:
determining whether to send the request based on activation probability (AP) values of the OBEs if the idle activation channel is available, wherein the AP values are determined based on current network congestion status; and
sending a request to reserve a channel to the RSE if the AP values of the OBEs are less than an AP value of the RSE.

10. The method as defined in claim 7, further comprising the step of reserving, by the RSE, a channel for transmitting data packets in response to the request from the OBEs.

11. The method as defined in claim 7, wherein the waiting periods of OBEs having a higher priority level are shorter than the waiting periods of OBEs having a lower priority level.

12. A computer readable medium storing computer executable code that when executed on a processor of a DSRC system comprising an RSE and a plurality of OBEs performs a method comprising the steps of:
determining a priority level for each of a plurality of OBEs with respect to reserving a channel between each OBE and an RSE;
assigning a waiting period to each of the plurality of OBEs based on their respective priority levels; and
sending, by the OBEs, requests to reserve a channel to the RSE after waiting the assigned waiting periods.

13. A carrier medium carrying computer readable code that when executed on a processor of a DSRC system comprising an RSE and a plurality of OBEs performs a method comprising the steps of:
determining a priority level for each of a plurality of OBEs with respect to reserving a channel between each OBE and an RSE;
assigning a waiting period to each of the plurality of OBEs based on their respective priority levels; and
sending, by the OBEs, requests to reserve a channel to the RSE after waiting the assigned waiting periods.

14. A DSRC system comprising:
an RSE;
a plurality of OBEs, wherein:
each OBE is assigned a priority level with respect to reserving a channel between
each OBE and an RSE;
each OBE is assigned a waiting period based on their priority levels; and
each OBE is configured to send a request to the RSE to reserve a channel after waiting the assigned waiting period.

15. The system as defined in claim 14, wherein the OBEs are further configured to:
perform carrier sensing to check if an idle activation channel is available to carry the request prior to sending a request to reserve a channel; and
send a request to reserve a channel to the RSE if the idle activation channel is available.

16. The system as defined in claim 15, wherein the OBEs are further configured to:
determine whether to send the request based on activation probability (AP) values of the OBEs if the idle activation channel is available, wherein the AP values are determined based on current network congestion status; and send a request to reserve a channel to the RSE if the AP values of the OBEs are less than an AP value of the RSE.

17. The system as defined in claim 14, wherein the RSE is configured to reserve a channel for transmitting data packets in response to the request from the OBEs.

18. The system as defined in claim 14, wherein the waiting periods of OBEs having a higher priority level are shorter than the waiting periods of OBEs having a lower priority level.

19. The system as defined in claim 14, wherein the priority levels of OBEs paying higher DSRC service subscription fees are assigned higher priority levels than those paying lower DSRC service subscription fees.

20. An OBE communicating with an RSE in a DSRC system, the ODE comprising:
an application layer module configured to send a data packet and a priority level;
a data link layer module configured to receive the data packet and the priority level and send the data packet and a waiting period associated with the priority level; and
a physical layer module configured to send a request to reserve a channel to the RSE after waiting the waiting period.

21. The OBE as defined in claim 20, wherein the physical layer module is configured to:
perform carrier sensing to check if an idle activation channel is available to carry the request prior to sending a request to reserve a channel; and
send a request to reserve a channel to the RSE if the idle activation channel is available.

22. The OBE as defined in claim 21, wherein the control module is configured to:
determine whether to send the request based on activation probability (AP) values of the OBEs if the idle activation channel is available, wherein the AP values are determined based on current network congestion status; and request that the physical layer send a request to reserve a channel to the RSE if the AP values of the OBEs are less than an AP value of the RSE.

23. The OBE as defined in claim 20, wherein the waiting period is inversely proportional to the priority level.
